(19) United States
(12) Patent Application Publication
(10) Pub. No.: US 2016/0269646 A1
(43) Pub. Date: Sep. 15, 2016

(54) DIVERSIONARY SYSTEM

(71) Applicant: Paul John Grata, Charlotte, NC (US)

(72) Inventor: Paul John Grata, Charlotte, NC (US)

(21) Appl. No.: 15/066,366

(22) Filed: Mar. 10, 2016

Related U.S. Application Data
(60) Provisional application No. 62/132,988, filed on Mar. 13, 2015.

(51) Int. Cl. H04N 5/232; F21V 33/00; G02C 7/10; F21V 9/08

(52) U.S. Cl. CPC H04N 5/23293; F21V 9/08; F21V 33/0056; G02C 7/104; F21W 2131/40

(57) ABSTRACT

A diversionary system includes a user apparatus in which a vision-assistance device attenuates light in a diversion spectrum and allows light in a perception spectrum, a deployable device that emits a cloud, which is opaque to the diversion spectrum and transparent in the perception spectrum, and a light emitter that emits or strobes in the diversion spectrum to illuminate the cloud. The deployable device may include a sound emitter. The user apparatus may be configured as head-worn unit and may include a filter that attenuates light in the diversion spectrum from entering the vision-assistance device.

### CROSS-REFERENCE TO RELATED APPLICATION

This application claims the benefit of priority of U.S. provisional patent application No. 62/132,988, titled “Diversionary System,” filed on Mar. 13, 2015, which is incorporated herein in its entirety by this reference.

### TECHNICAL FIELD

The present disclosure relates to devices and methods for disorienting and/or distracting an intended subject while maintaining orientation and sight of a user. More particularly, the present disclosure relates to devices and methods for creating an illuminated smoke or gas cloud, optionally with sound, while a user maintains sight and situational control.

### BACKGROUND

Police and military actions sometimes require a balance between subduing or capturing individuals or groups suspected of crimes or terrorism and yet preserving the safety of the same people or their captives. In some situations, even where the safety of police and military personnel could obviously be preserved by using heavy artillery or explosive munitions to terminate all suspects and even level architectural structures, peripheral injuries and even the deaths of suspects, who may have crucial information, are to be avoided. Thus, police and military personnel are sometimes put at risk when breaching situations where armed suspects are barricaded and/or have hostages with them in close proximity.

Night vision systems are available to assist in assault actions in darkness, and stun grenades are available to momentarily blind and deafen intended subjects. However, not all assault scenarios occur under cover of darkness and even stun grenades have been known to cause fires and unintended deaths.

Improved systems and methods are needed for disorienting and/or distracting an intended subject while maintaining orientation and sight of a user

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

In at least embodiment, diversionary system includes: a user apparatus including a vision-assistance device that attenuates light in a first spectrum and allows light in a second spectrum to pass; a deployable device including an element that emits a cloud, wherein the cloud is opaque to, scatters or diffuses light in the first spectrum, and wherein the cloud is translucent or transparent to light in the second spectrum; and a first light emitter that emits light in the first spectrum to illuminate the cloud.

In at least one example, the deployable device includes the first light emitter.

In at least one example, the deployable device further includes a sound emitter.

In at least one example, the deployable device further includes an electronic controller that controls the first light emitter to strobe.

In at least one example, the user apparatus is configured as a head-worn unit.

In at least one example, the user apparatus includes a filter that attenuates light in the first spectrum from entering the vision-assistance device.

In at least one example, the filter allows light in the second spectrum to enter the vision-assistance device.

In at least one example, the first spectrum includes visible light, and the second spectrum includes at least one of infrared light and ultraviolet light.

In at least one example, the first spectrum includes visible light, and the second spectrum includes at least one of infrared light and ultraviolet light.

In at least one example, the first spectrum includes visible light and infrared light, and the second spectrum includes ultraviolet light.

In at least one example, the first spectrum excludes one or two of infrared light, visible light, and ultraviolet light; and the second spectrum includes the one or two of infrared light, visible light, and ultraviolet light excluded by the first spectrum.

In at least one example, the vision-assistance device includes a camera sensitive in the second spectrum.

In at least one example, the vision-assistance device includes a screen that displays images.

In at least one example, the user apparatus includes a power source and an electronics controller that controls the vision-assistance device.

In at least one example, the user apparatus includes a second light emitter that emits light in the first spectrum to illuminate the cloud.

In at least one example, the first spectrum includes light in a continuous band of wavelengths.

In at least one example, the first spectrum includes light in discrete separated wavelength bands.

In at least one example, the first light emitter includes a light-emitting diode.

In at least one example, the deployable device includes a capsule configured to be thrown by hand

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is a diagrammatic representation of a diversionary system according to at least one embodiment.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Systems and methods described herein are meant to provide an optical diversion in a light spectrum visible to intended subjects. Herein, such a light spectrum is nominally described as a diversion spectrum. While an optical diversion is provided in the diversion spectrum, one or more users maintain visual perception or contact in another light spectrum without being affected by the optical distraction in the diversion spectrum. The light spectrum in which one or more users maintain visual perception or contact is nominally described herein as the perception spectrum. A user benefits from the use of an apparatus that includes a vision-assistance device and filter as described below, whereas an unaided subject experiences disorientation or at least visual impairment. This provides the user with significant control and tactical situational advantages over the unaided subject. An additional audio distraction can be utilized to supplement optical and other disorientating effects of the system.

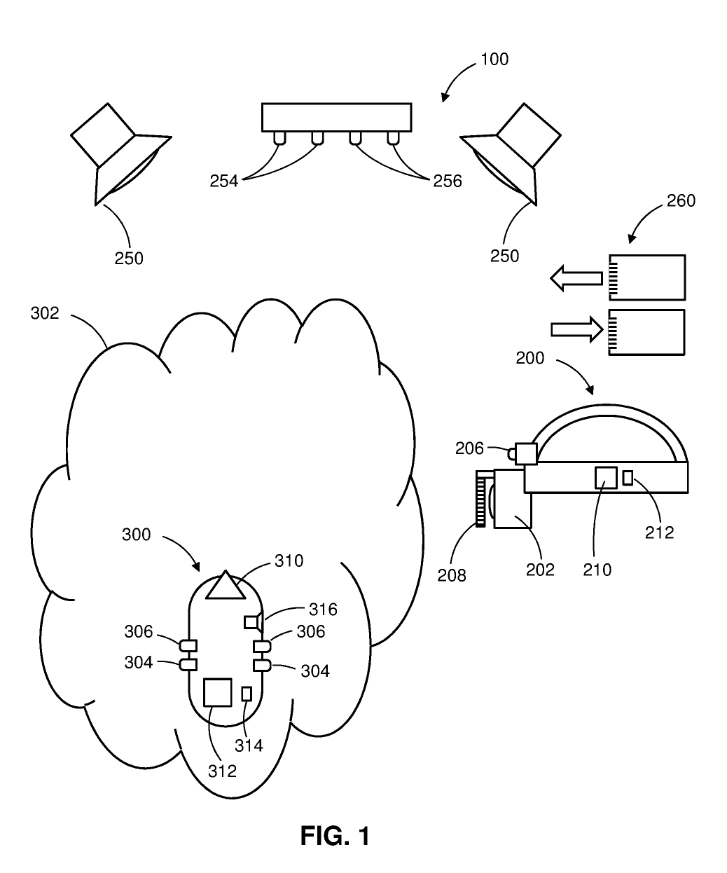

As shown in FIG. 1, a diversionary system 100 according to at least one embodiment includes a user apparatus 200 and a deployable device 300. The system 100 works by creating a smoke, gas or mist cloud 302, which is opaque to or significantly scatters or diffuses light in a diversion spectrum. The cloud 302 is illuminated by diversion-spectrum light emitters 304, which are mounted on the exterior of the deployable device 300 or are visible through an outer shell, grate, or apertures. For example, the diversion-spectrum light emitters 304 may be LEDs set to strobe. The light of the diversion-spectrum light emitters 304 in conjunction with the cloud 302 results in visual disorientation for intended subjects.

The cloud 302, however, passes, is translucent, or is transparent in a perception spectrum. The user apparatus 200 includes a vision-assistance device 202 that filters, blocks or attenuates diversion-spectrum light and allows or enhances perception-spectrum light to pass or otherwise present an image to the user via the perception spectrum, permitting the user of the apparatus 200 to maintain vision. In the illustrated embodiment, the user apparatus 200 is configured as a head-worn unit, and includes a filter 208 placed forward on the vision-assistance device 202 to safeguard against blinding in any spectrum outside of the perception spectrum. The filter 208 is used to prevent light beyond the applicable perception spectrum from affecting either or both of the vision-assistance device 202 and user. Thus, the filter 208 attenuates diversion-spectrum light and allows perception-spectrum light to pass to the vision-assistance device 202.

Perception-spectrum light emitters 206 and 306 provide perception-spectrum illumination to allow the user to see through the cloud 302 in the perception spectrum using the vision-assistance device 202, while being unaffected by potentially disorienting and blinding effects of the diversion-spectrum light strobing or otherwise directed upon or within the cloud 302. As such, the system 100 can visually disorient a subject who does not benefit from the vision-assistance device 202 and filter 208 while allowing the user of the user apparatus 200 to see via the perception spectrum.

In at least one example, the diversion spectrum is within or encompasses the visible-light spectrum that is normally visible to human eyes, and the perception spectrum includes infrared (IR) and/or ultraviolet (UV) light. In that example, a subject unaided by the user apparatus 200 is disoriented or at least visually impaired by the cloud 302 illuminated by the diversion-spectrum light emitters 304. In that example, the cloud 302 is opaque to or significantly blocks or diffuses light in the visible light spectrum, and passes, is translucent, or is transparent to infrared (IR) and/or ultraviolet (UV) light. In one case according to such an example, the diversion-spectrum light emitters 304 emit white light. Diversion-spectrum light emitters 304 emitting visible spectrum light according to this example might furthermore emit light including multiple colors, singular colors, alternating colors or any combination thereof.

In other examples the cloud 302 is opaque to or significantly blocks or diffuses light in a diversion spectrum that includes one or two of IR light, visible light, and UV light, while the vision assistance 202 and filter 208 allow light to pass or otherwise present an image to the user via a perception spectrum that includes the remainder of IR light, visible light, and UV light not included in the diversion spectrum. Put another way, the diversion spectrum excludes one or two of IR light, visible light, and UV light, and the perception spectrum includes the one or two of IR light, visible light, and UV light excluded by the diversion spectrum.

In at least one embodiment, which may be useful for military use, the cloud 302 is opaque to or significantly blocks or diffuses light in a diversion spectrum that includes IR light and visible light, while the vision assistance 202 and filter 208 pass or otherwise present an image to the user via a perception spectrum that includes UV light not included in the diversion spectrum. Such an embodiment may be useful to disorient or visually impair unaided eyes and IR vision systems such as night-vision systems.

The diversion spectrum may include a broad continuous band of wavelengths or discrete separated wavelength bands. Similarly, the perception spectrum may include a broad continuous band of wavelengths or discrete separated wavelength bands. The diversion-spectrum and perception-spectrum need not be entirely above or below each other with regard to wavelength. For example, the diversion spectrum can include visible-wavelength light while the perception spectrum includes light of IR and UV wavelengths.

In the illustrated embodiment, the deployable device 300 is shown as a capsule that can be lobbed or launched like a grenade. In that other embodiments, the deployable device 300 can be installed or otherwise deployed in a desired location, for example in a location where an incident is expected or arranged. Furthermore, in the illustrated embodiment, perception-spectrum light emitters 306 are mounted on the deployable device 300 to assist in illuminating the area of the deployable device 300 with light perceptible to the user of the user apparatus 200. Also, in the illustrated embodiment, perception-spectrum light emitters 206 are mounted on the user apparatus 200 as well.

In the illustrated embodiment, the deployable device 300 houses an element 310 that emits or produces a gas, smoke or mist described herein as the cloud 302. The deployable device 300 in FIG. 1 further includes control electronics 312, a power source 314 such as a battery, the diversion-spectrum light emitters 304, perception-spectrum light emitters 306, and a sound emitter 316, which can be for example a buzzer or other speaker device. The deployable device 300 is designed to be deployed into an enclosed area such as a room.

Upon activation the deployable device 300 releases or generates the cloud 302 which rapidly fills the area. The cloud 302 attenuates, reflects, scatters, or diffuses light in the diversion spectrum, and thus is opaque or visually occluding in nature and preferably reflective or diffusive in the diversion spectrum, thus obstructing vision for those intended to be controlled, subdued, overcome or neutralized. The cloud 302 poses little or no obstruction to light in the perception spectrum, permitting users of the user apparatus 200 to visualize the scenario using the vision-assistance device 202 so as to control the outcome, for example using non-lethal force and tactics if possible.

The diversion-spectrum light emitters 304 may be activated to produce a rapid strobe effect. In such an embodiment, the diversion-spectrum light emitters 304 do not emit any appreciable perception-spectrum light in strobe fashion. Perception-spectrum light emitters 206 and 306 can emit light in a continuous manner to enhance vision for the wearer of the user apparatus 200. The strobe pattern and/or beat frequency of the perception-spectrum light emitters 304 may be manipulated or programmed prior to deployment to create a faster or slower strobe effect.

Upon deployment of the deployable device 300, the cloud 302 fills the surrounding area and creates an initial level of disorientation by preventing direct line of sight and limiting effective vision unaided by the user apparatus 200 to a significantly shortened range. The addition of strobing light from the diversion-spectrum light emitters 304 on the deployable device 300 enhances disorientation by preventing any continuity in the vision of the subjects, effectively blinding them. The light is reflected, scattered and diffused within and upon the cloud 302, effectively amplifying the area of effect of the light-based diversion. In addition, the cloud 302 blurs the source of the light, thus preventing the subject from locating themselves relative to the light source to minimize their likelihood of disabling or locating the deployable device 300. Multiple deployable devices 300 can be deployed to further enhance disorienting effects.

Further, sound can be incorporated into the deployable device via the sound emitter 316 to prevent audio communication between subjects. The controller 312 can cause the sound emitter 316 to release shrill siren sounds, percussive booming sounds, or even verbal commands to surrender.

In at least one embodiment, the vision-assistance device 202 includes a camera system sensitive in the perception spectrum which displays images via one or more small screens within the head unit. In at least one embodiment, the vision-assistance device 202 operates as similar to IR-based night-vision technologies in use currently. The vision-assistance device 202 illustrated in FIG. 1 includes the filter 208, which blocks any light wavelengths outside the perception spectrum. The user apparatus 200 includes an electronics controller 210 and power source 212, for example a battery, to power and control onboard devices such as the vision-assistance device 202 and perception-spectrum light emitter(s) 206.

For example, in an embodiment in which the perception spectrum is in the IR range, the filter blocks wavelengths below approximately 850 nanometers (nm). The user apparatus 200 in that embodiment includes IR light emitters 206 to assist in illuminating an area in IR spectrum light. The filter 208 in that embodiment is used to prevent visible-spectrum light from affecting both the vision-assistance device 202 and the user. The filter 208 is placed forward on the vision-assistance device 202 to safeguard against blinding in the visible spectrum. The user apparatus 200 is still capable of allowing the user to see light in the IR range, allowing the user a clear IR-based view of the scenario and subjects to be subdued through the cloud 302. Utilizing the IR-light emitters 206 on the user apparatus 200 allows the user to see through the cloud while preventing the subject from locating the user, as the IR-light emitters will be virtually invisible to an unaided subject whose unaided vision is ineffective in the IR range and is disrupted in the visible spectrum by the cloud 302 and other disorienting light effects of the deployable device 300.

Light emitters described herein may be, for example, light-emitting diodes (LEDs). For example, near-IR LEDs may emit light of wavelengths equal to and greater than 850 nm, whereas visible light may be emitted between 450 nm and 550 nm wavelengths. The filter 208 may block light having wavelengths greater than 750 nm for use with a perception spectrum having wavelengths shorter than 750 nm. The filter 208 may block light having wavelengths shorter than 750 nm for use with a perception spectrum having wavelengths greater than 750 nm.

The cloud 302 may be produced with aerosolized glycerine or glycol. The cloud can be formed via a vaporization process in which a liquid solution comes in contact with an electrically heated element (such as nickel-chromium wire) causing it to vaporize instantly. The element and release of the liquid solution will be timed via on-board circuitry such as a delay circuit. This can potentially be user programmable or defaulted for a standard delay in line with existing flash-bang or grenade systems. This deployment of the cloud may resemble that of fog machines (or e-cigarettes) in operation. Back pressure may be added to increase the flowrate of the fluid across the heating element which will increase the rate at which a room may be filled. This can be done with a separate pressure chamber (CO₂) or via a single chamber that is back-loaded with a propellant such as CO₂, according to at least one embodiment. The propellant may have no effect on the chemical composition or characteristics of the smoke. Alternately a fine particulate powder may be used to create the smoke (aerosol) wherein the powder is stored in a chamber and a back-pressure (via a CO2 cartridge or similar) is injected forcing the powder to deploy. A secondary element can be added from another chamber to increase the viability or aerosol characteristics of the powder (creating more or less density or changing the spectral properties of the mix). This system of deployment is similar to air-brushing and opens up the possibilities of different materials or chemical compositions of the aerosol. Glycol or glycerine can be used in this system as well and may have a different composition than above (aerosol vs smoke; likely differing in particle size).

The system 100 may be adapted as a general security system for buildings by utilizing a canister which deploys the cloud 302 in security breach situations, such as when a store or bank robbery scenario must be stormed by authorities attempting to rescue hostages. The system may also be used to prevent robbers from being able to rob a store without hostages being involved. It would confuse and disorient the robbers preventing them from easily escaping, forming defensive positions or finding the valuables they intend to steal. The cloud 302 can fill a building's interior while additional facility-mounted camera systems 250 configured for perception-spectrum based visualization in a similar manner to the vision-assistance device 202 of the user apparatus 200 are positioned to surveil and record occurrences, even facilitating remote viewing and information assistance to breaching police or troops. The system 100 may also include facility-mounted strobing diversion-spectrum light emitters 254, to further disorient intended subjects, and facility-mounted perception-spectrum light emitters 256 to assist in illuminating an area in perception-spectrum light to assist breaching police or troops who use head units 200. The strobing visible light and clouds 302 will hinder the ability of unaided subjects such as robbers and terrorists to navigate and/or steal. A forced air evacuation system 260 can be utilized to rapidly remove clouds 302 upon arrival of law enforcement or other officials.

The system 100 may be designed for such use in law enforcement and military breaches, for example where non-lethal force may be preferred and when more explosive devices such as stun grenades pose a danger. Other uses include similar military procedures and training purposes. The system 100 could also be used to provide security for buildings. Additional uses can include riot scenarios and instances where inmates in jails must be subdued.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A diversionary system comprising:
a user apparatus comprising a vision-assistance device that attenuates light in a first spectrum and allows light in a second spectrum to pass;
a deployable device comprising an element that emits a cloud, wherein the cloud is opaque to, scatters or diffuses light in the first spectrum, and wherein the cloud is translucent or transparent to light in the second spectrum; and
a first light emitter that emits light in the first spectrum to illuminate the cloud.

2. A diversionary system according to claim 1, wherein the deployable device comprises the first light emitter.

3. A diversionary system according to claim 2, wherein the deployable device further includes a sound emitter.

4. A diversionary system according to claim 2, wherein the deployable device further includes an electronic controller that controls the first light emitter to strobe.

5. A diversionary system according to claim 1, wherein the user apparatus is configured as head-worn unit.

6. A diversionary system according to claim 5, wherein the user apparatus includes a filter that attenuates light in the first spectrum from entering the vision-assistance device.

7. A diversionary system according to claim 6, wherein the filter allows light in the second spectrum to enter the vision-assistance device.

8. A diversionary system according to claim 1, wherein the first spectrum includes visible light, and the second spectrum includes at least one of infrared light and ultraviolet light.

9. A diversionary system according to claim 1, wherein the first spectrum includes visible light, and the second spectrum includes at least one of infrared light and ultraviolet light.

10. A diversionary system according to claim 1, wherein the first spectrum includes visible light and infrared light, and the second spectrum includes ultraviolet light.

11. A diversionary system according to claim 1, wherein:
the first spectrum excludes one or two of infrared light, visible light, and ultraviolet light; and
the second spectrum includes the one or two of infrared light, visible light, and ultraviolet light excluded by the first spectrum.

12. A diversionary system according to claim 1, wherein the vision-assistance device includes a camera sensitive in the second spectrum.

13. A diversionary system according to claim 12, wherein the vision-assistance device includes a screen that displays images.

14. A diversionary system according to claim 13, wherein the user apparatus includes a power source and an electronics controller that controls the vision-assistance device.

15. A diversionary system according to claim 14, wherein the user apparatus includes a second light emitter that emits light in the first spectrum to illuminate the cloud.

16. A diversionary system according to claim 1, wherein the first spectrum includes light in a continuous band of wavelengths.

17. A diversionary system according to claim 1, wherein the first spectrum includes light in discrete separated wavelength bands.

18. A diversionary system according to claim 1, wherein the first light emitter comprises a light-emitting diode.

19. A diversionary system according to claim 1, wherein the deployable device comprises a capsule configured to be thrown by hand.
